(19) United States
(12) Patent Application Publication
(10) Pub. No.: US 2014/0214783 A1
(43) Pub. Date: Jul. 31, 2014

(54) COMPUTER-IMPLEMENTED METHOD FOR DATA MANAGEMENT OF PRODUCT VARIANTS IN CONTROL UNIT DEVELOPMENT

(71) Applicant: dSPACE digital signal processing and control engineering GmbH, Paderborn (DE)

(72) Inventors: Dirk STICHLING, Paderborn (DE); Ansgar KUHLMANN, Paderborn (DE); Andreas BOMERT, Paderborn (DE); Daniel BECKE, Bad Lippspringe (DE); Jobst RICHERT, Lippstadt (DE)

(73) Assignee: dSPACE digital signal processing and control engineering GmbH, Paderborn (DE)

(21) Appl. No.: 14/167,019

(22) Filed: Jan. 29, 2014

Related U.S. Application Data
(60) Provisional application No. 61/757,971, filed on Jan. 29, 2013.

(30) Foreign Application Priority Data
Jan. 29, 2013 (EP) EP 13152999.2

(51) Int. Cl. G06F 17/30

(52) U.S. Cl. CPC G06F 17/30289
USPC 707/695; 707/722

(57) ABSTRACT

A computer-implemented method for data management of product variants in control unit development is provided. Consistent data management is ensured by initially specification of product features in a variant model, specification of components in at least one domain, and definition of feature/component dependencies by associating components with at least one product feature, and subsequently specification of at least one product variant of interest by selecting product features, specification of at least one domain of interest, automated identification of the components pertaining to the product variant of interest through automated evaluation of the feature/component dependencies, and automated output of the identified components.

This nonprovisional application claims priority to European Patent Application No. 13152999.2, which was filed in Europe on Jan. 29, 2013, and to U.S. Provisional Application No. 61/757,971, which was filed on Jan. 29, 2013, and which are both herein incorporated by reference.

### BACKGROUND OF THE INVENTION

1. Field of the Invention

The present invention relates to a computer-implemented method for data management of product variants in control unit development.

2. Description of the Background Art

Methods for data management of product variants are known from widely disparate areas of technical development, and are used primarily in technical products whose development requires the product to be adapted to different requirements, for example. The complex task of data management in the development of product variants is discussed below for the field of control unit development.

Control units today are typically understood to be robust small computers for industrial use that usually have integrated I/O interfaces. Frequently equipped with real-time operating systems, control units execute programs that connect in the broadest sense through the I/O interface to a technical process which is to be controlled and that act on this process in a desired manner. Control units of the type described are used intensively in automaking, for example. The development of control units has in the meantime become an important element in the development of production motor vehicles.

The development of a control unit can be subdivided by topic into different fields, which hereinafter are referred to as domains; these domains can have different components. In control unit development, a domain can be the domain of requirements specifications with the different requirements specifications as components, for example. Additional possible domains are the domain of test cases for testing the various requirements, the domain of test system descriptions—for example, in the form of a hardware description of a hardware-in-the-loop test system, the domain of mathematical models for simulating the control unit environment, and the domain of parameter sets for parameterization of the models; this listing is by way of example and may be expanded as desired.

Typically, different product variants arise in the development of complex products. These product variants differ from one another in certain product features. The sum of all product features taken together makes up the variant model. The product features critical for making a distinction can be broken down into categories that are referred to below as feature categories. Such a categorization of the product features facilitates the overview of product features, but is not essential for the teaching claimed herein. Possible examples of different feature categories in control unit development are the country where the control unit is to be used, with the product features Europe, North America, and Asia; the type of power plant (self-ignited engine, spark-ignited engine), with sub-product features of 4, 6, 8, and 12 cylinder engines; or vehicle body with the sub-product features of sedan, station wagon, and convertible. The product features are possible characteristics that different variants of the product can differ by; accordingly, product variants result from the selection of product features that characterize a specific product variant. In order to take the aforementioned examples further, one product variant could be the control units for four-cylinder self-ignited engines intended for the European market, for example. Another product variant could be the control units for self-ignited engines intended for the American market, where the necessity for distinguishing between these different product variants can arise, for instance, from different manufacturer requirements in the different markets or from different legal requirements in the said regions, for example.

It is evident in view of the background presented that various components in the domains only apply to certain product variants. If it is necessary to distinguish between, for example, the product variants of the control units for four-cylinder self-ignited engines for Europe and the USA, then there may possibly be requirements that differ, at least in part, in the domain of the requirements specifications, test cases that differ, at least in part, in the domain of test cases, controls that differ, at least in part, in the domain of control algorithms, or parameters and/or parameter sets that differ in the domain of parameters or parameter sets.

On the whole, it represents a significant problem to reliably track the dependencies of product variants and components during a development process, particularly when feature categories change within the variant model. Another problem can include simply in reliably identifying the valid components from certain domains corresponding to a certain product variant, particularly when the information on the components of the various domains is only stored in a distributed manner. Finally, it is thoroughly problematic to maintain consistency in the indicated variety of information that composes and accompanies the development project. For instance, a change in the variant model raises the question of the degree of change in the relationship of an altered product variant to the components.

### SUMMARY OF THE INVENTION

It is therefore an object of the present invention to provide a computer-implemented technical solution with which it is possible to resolve the problems discussed in connection with the data management of product variants in control unit development.

The object derived and presented above is attained in a computer-implemented method for data management of product variants, in particular in control unit development, by the means that initially product features in a variant model are specified, that components in at least one domain are specified, and that feature/component dependencies are defined by associating components with product features. It is immaterial whether the product features or the components are specified first; all that is important is that the user of the method is given the opportunity to systematically specify product features and systematically specify components in domains, with it being possible to subdivide the product features into feature categories. The specification of product features and components can take place in a database, for example. The feature/component dependencies are information that indicates what component is linked to what product feature or product features, or in other words, what product feature a certain component is relevant for. One component can of course also be relevant for different product features.

By means of the storage of the defined feature/component dependencies, which can be stored in a memory of a computer, the method according to the invention makes it possible to subsequently specify at least one product variant of interest by selecting product features, and to specify at least one domain of interest, whereupon the components from the domains of interest associated with the product variants of interest can automatically be identified through automated evaluation of the previously defined feature/component dependencies. The automated output of the identified components then takes place. Accordingly, the product variant characterized by the selection of product features functions more or less as a filter that is used on the totality of the domain data in order to obtain therefrom the components of interest for the product variant.

The automated evaluation of the feature/component dependencies can include, for example, in that all feature/component dependencies are searched, and the particular dependencies are extracted that include a connection to at least one product feature of the specified product variant of interest while simultaneously being connected with a component located in the specified domain of interest. The automatic output of the identified components can have an informative character, for example through display of the components previously identified automatically, but the identified components can also be output as data units, and thus be made available for further processing. It is possible, for instance, that, using the computer-implemented method described, all the test cases are identified that are—also—connected with at least one product feature of the specified product variant of interest, and are delivered directly to a test system in which a corresponding test is carried out.

In an embodiment of the method, provision is made for the variant model, the domains, and the feature/component dependencies to be collected in a common database. In this exemplary embodiment, the entire development process is represented in a uniform, common database, for which reason the computer-implemented method has complete information on all dependencies at all times. In particular, the common database here includes not only organizational information on the components of the domains, but also the actual information processed in the various domains. Accordingly, the common database doesn't only have the information that certain test cases and test sequences exist for the control unit, that certain mathematical models exist for simulating the control unit environment, and that certain parameters are present, but instead it contains and manages the test case descriptions, the code for the test sequences, the description of the mathematical models in terms of data and content, and the parameters with the values associated with them, in and of themselves.

For example, when one of the mathematical models is processed by the software tool that was used to produce the mathematical model, then this software tool ideally accesses the common database. On the whole, then, the procedure according to the method implements a work environment in the manner of a client-server system in which all the various clients working with different domain data work with a consistent state of the uniform database. Preferably, in this case the computer-implemented method is implemented by a single, integrated application that has access to the entire database. In the case of a method implemented in this way and a database configured in this way, it is no longer necessary to acquire corresponding information from the different domains if these domains are equipped with different development tools and separate data administration. While this may indeed still be the case in an integrated solution for data management of product variants, the data of interest from the various domains will in any case also be kept available along with the information on the variant model in the uniform, common database.

In a further development of the method, the defined feature/component dependencies are existence dependencies and/or value dependencies. In the case of an existence dependency, the only information of interest is that a dependence exists between at least one product feature and a component of a domain. In the case of a value dependency, the actual data concealed behind the associated component of the domain is additionally of interest. Thus provision is also made that at least one data item is specified for the component involved. These data can be the values with which parameters are populated, for example. For instance, a parameter P1 in the control of an anti-lock braking system can have different values for a control unit intended for the European market and a control unit intended for the US market. In the case of a value dependency of this nature, provision is made in particular that at least one data item can be stored for each feature combination during specification of multiple dependencies between a component of a domain and one or more product features.

In an embodiment of the computer-implemented method, provision is made that the components within a domain are stored in separate data units, e.g., in separate files. In the case of the domain of requirements specifications, this means that the specifications are stored separately and are available as separate data units, which is to say that they are not mixed with other specifications in a common data unit. This is especially advantageous when the automated evaluation of the feature/component dependencies includes an existence test for the dependency, which is to say all that is being tested is whether a dependency exists between the specified product variant of interest and a component in at least one specified domain of interest. In this case, the option exists to output the data units associated with the identified components without the intermediate step of a special extraction; in particular the data units can be output in unchanged form.

In an embodiment of the method, the components within a domain are stored in a common data unit so that the components are not present separately, in other words. This can make sense for the storage of parameters and parameter sets, for example. For instance, certain parameters and parameter sets for parameterization of a mathematical model or of a control algorithm may differ only through different values for certain parameters, wherein the parameters are themselves the same, or at least some of them appear in multiple parameter sets. Through skilled organization of multiple parameter sets in a common data unit, it is possible to obtain and communicate a good overview of similarities and differences between the various parameter sets in a very simple manner. When the components within a domain are stored in a common data unit, then provision is made for the automated evaluation of the feature/component dependencies to initially include existence test for the dependency, wherein the entries associated with the identified components are extracted from the common data unit and are output. Once again, the output can have merely an informative character, but it can also serve to make the extracted data available for other automated processes, in particular wherein the identified entries from the common data unit are output in a separate file.

In an embodiment of the method, the product features are defined in a hierarchically structured manner. Here, hierarchically structured means that product features are subdivided into product subfeatures, wherein the hierarchical structure can also propagate to the product subfeatures on lower levels of the hierarchy. One possible example for such a hierarchical structuring of product features is the regional association. For instance, the feature category “countries” could have the product features “Europe”, “Asia”, and “North America.” The product feature “Europe” could be hierarchically structured, e.g., into the product subfeatures “Germany”, “France”, “Great Britain”, and “elsewhere”. In a further development of the method claimed, the hierarchically structured definition of the feature categories makes it possible for a feature/component dependency defined for a product feature on a higher level of the hierarchy to also be transferred to variants that have the product feature on a lower level of the hierarchy. When explained using the above example, this means that a component dependency defined for the variant of European self-ignited engines, for instance, also extends to sub-variants that rank lower on the hierarchy, and hence that the defined component dependency also applies to the self-ignited variants that have been defined as dedicated for “Germany”, “France”, “Great Britain”, or “elsewhere”. Hierarchical behavior of this nature is especially advantageous for the case of data administration in which the components have been stored within a domain in a common data unit. Thus, in a tabular listing of all parameter sets for the relevant variants, for example, it is very easy to display and determine whether or not certain parameters also apply to hierarchically subordinate variants. It is then immediately evident whether a parameter exists at all for a particular variant, which is to say that an existence dependency is present. In the case of the existence of a parameter for a certain variant, the value can then also easily be transferred to lower-ranking variants on the hierarchy; the subordinate variants then depend on the higher-ranking variants in terms of value, or in other words a value dependency is present. In addition, provision can be made for value transfers into lower-ranking variants on the hierarchy to only take place when no dedicated value specifications exist here.

An embodiment of the method provides for one value dependency to be defined in each case between one component and multiple product features in multiple feature categories. If VK1, VK2, . . . , VKn are the feature categories in question and vk1, vk2, . . . , vkn are the applicable quantities of the feature/component dependencies in the form of value dependencies, then according to the invention vk1*vk2* . . . *vkn value specifications are made for the component for the various combinations of the product features.

Within the scope of the computer-implemented method under discussion, the defined feature/component dependencies can also be used in a further-reaching way to ensure consistent data management. Thus, provision is made in one embodiment of the method according to the invention that when the deletion of a previously defined product feature is stipulated, a determination is made as to whether the product feature to be deleted is associated with components, something which is possible at any time through evaluation of the existing feature/component dependencies. In the event that the feature to be deleted is indeed associated with components, a conflict exists. Attention is initially drawn to the conflict in that the existing feature/component dependencies are pointed out, and the deletion of the product feature to be deleted is suspended.

In an embodiment of the method, however, not only is attention drawn to a case of conflict that would result in a loss of some data, but in addition a resolution to the conflict is actively and automatically offered. This is accomplished by the means that, when an existing feature/component dependency is present, a new version of the database being managed is generated in the form of a copy of the database being managed—if applicable after approval by the user—wherein the product feature to be deleted is removed in the newly generated version of the database being managed, or the conflict is otherwise resolved. For example, a feature/component dependency could reference a higher-ranking product feature if a lower-ranking product feature has been deleted. This measure ensures that the product feature to be deleted cannot disappear from the data management of the product features. As a result of the versioning, product variants to be deleted are preserved in an old version, where they continue to be accessible. The further development of the variant model, as well as the aggregate having variant model, domains, and feature/component dependencies, can thus move forward in new versions of the database. In an advantageous further development of the method, the feature/component dependencies associated with the deleted product feature are deleted as well, since one of the two partners in the connection is no longer present. The creation of a copy of the database being managed includes, in particular, copies of the variant model, the domains, the definition of product features, and the definition of feature/component dependencies.

In another measure to promote consistent data management, the components that have feature/component dependencies solely with the deleted product feature are automatically deleted from the database being managed. This measure can also be made subject to the approval of the user of the method so that no unintended or imprudent deletions take place in the database.

The deletion of a product feature is not the only condition under which creation of a new version can seem sensible or necessary; instead, the desire to create a new version of the database can also arise for other reasons, for instance in order to document a stage of development. Surprisingly, it has become apparent that handling different versions can easily be supported by the proposed method for data management of product variants. Thus, in a further development of the method, a new version of the variant model is generated through a modifiable copy of an old version and/or a new version of the domain model having all domains and all feature/component dependencies is generated through a modifiable copy of an old version of the domain model. Using the further developed method, it is therefore possible to generate new versions of the variant model and/or of the domain model. Thus it is possible, for example, to continue developing the variant model in a new version while the old variant model is still being processed together with the old domain model and the feature/component dependencies between these two models.

When a new version of the variant model has been created, the desire will arise to again establish an association between the variant model in the new version and components in the applicable domains, while a new version of the domains does not yet exist. Provision is thus made according to the invention that, during a change from an old version of a domain model to a new version of the variant model, first a new version of the domain model is created by copying the old version of the domain model, and the feature/component dependencies associated with the old version of the variant model are automatically transferred to the new version of the variant model, with the automatic transfer taking place through the identification of correspondences. In particular, provision is made for the automatic identification of correspondences to take place directly through evaluation of explicitly stored references—and thus also independently of names—through comparison of names and/or feature combinations of the feature categories in the old version of the variant model with names and/or with feature combinations of the feature categories in the new version of the variant model.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a hierarchically structured variant model with product features in feature categories;

FIG. 2 shows the definition of feature/component dependencies through the association of components with product features;

FIG. 3 shows the definition of product variants of interest through the selection in each case of product features from FIG. 1;

FIG. 4 shows the automated evaluation of feature/component dependencies according to the product variants of interest, and the output of the identified components;

FIG. 5 shows the storage of components within a domain;

FIG. 6 shows the automated evaluation of feature/component dependencies according to product variants of interest with value dependencies in accordance with a first example;

FIG. 7 shows the automated evaluation of feature/component dependencies according to product variants of interest with value dependencies in accordance with a second example;

FIG. 8 shows the transfer of feature/component dependencies to product variants with product features on a lower hierarchy level;

FIG. 9a, 9b show the versioning of the database in the case of conflict when a defined product feature is being deleted;

FIG. 10a, 10b show the automated resolution of inconsistencies in the database through versioning and deletion of incomplete feature/component dependencies; and

FIG. 11 shows the separate generation of new versions of the variant model and/or of the domain model.

### DETAILED DESCRIPTION

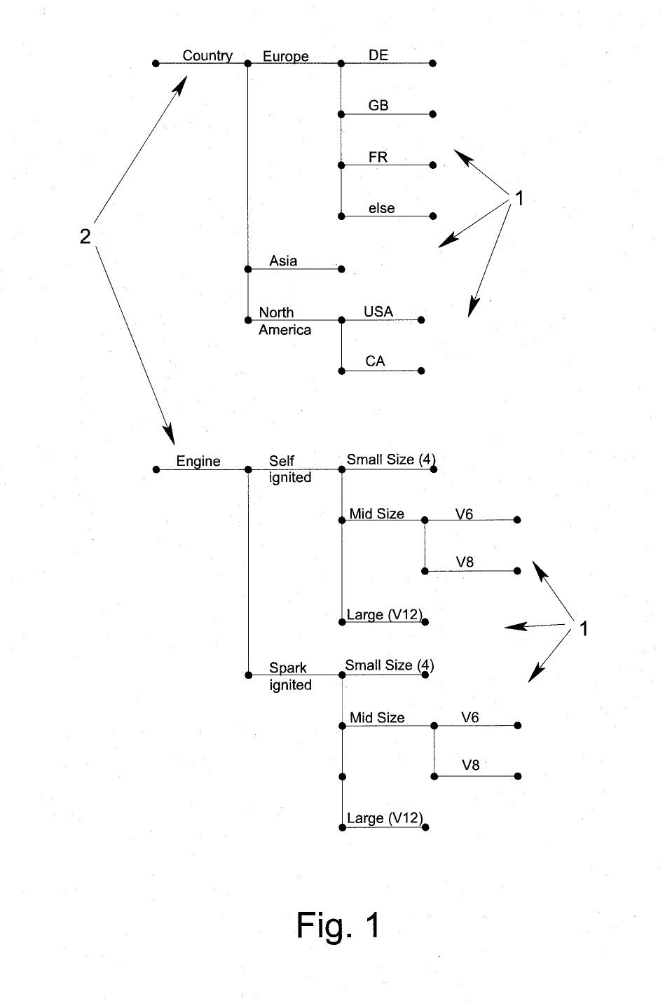

Shown in FIG. 1, firstly, is the part of the computer-implemented method for data management of product variants in control unit development that is concerned with the specification of product features 1, which here are additionally subdivided into feature categories 2. Shown here as feature categories 2 are the country (location of use) and the engine type. The product features 1 are the features that turn out to be suitable or necessary criteria for distinguishing between different product variants within the framework of product development.

Accordingly, the “country” feature category 2 breaks down into the product features 1, namely Europe, Asia, and North America, with the Europe product feature being subdivided into the further product features DE, GB, FR and elsewhere. The product features can thus be structured hierarchically. Similar applies to the “engine” feature category 2, which deals with the power plant of the vehicle for which a certain control unit is to be developed in the present example. Accordingly, the “engine” feature category 2 breaks down into the product features 1 of self-ignited and spark-ignited. The aforementioned product features 1 are then further subdivided into different engine sizes, here shown as a function of the number of cylinders.

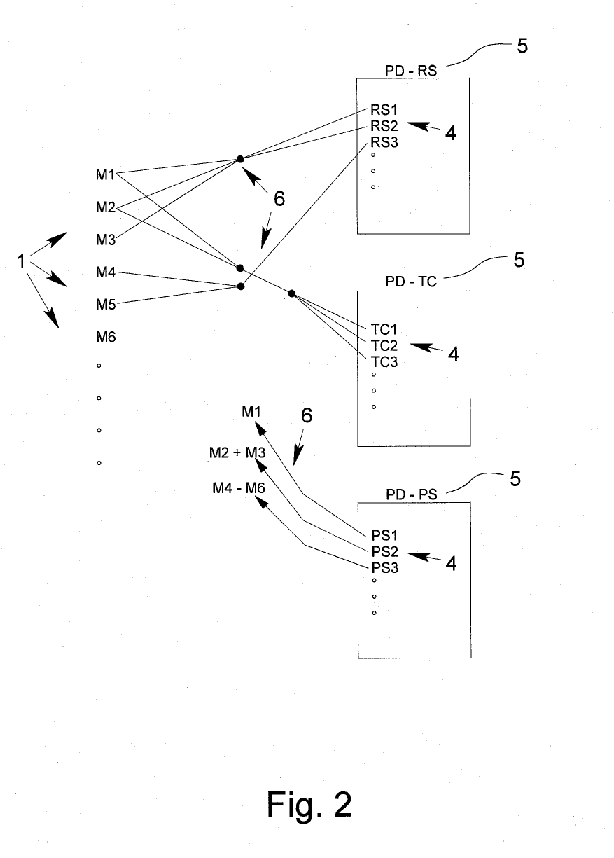

FIG. 2 shows the definition of feature/component dependencies 6 through the association of components 4 with product features 1. All product features 1 of the variant model from FIG. 1 are no longer shown in detail; instead, only the features M1, M2, . . . , M6 that are involved in feature/component dependencies 6 are shown. Let us assume that the feature M1 is the feature GB in the country feature category, for example. Visible in the drawing are the specified components 4 composed of RS1, . . . , TC1, PS1, . . . in different domains 5, namely PD-RS PD-TC, and PD-PS. Here, PD-RS stands for the domain of requirements specifications, PD-TC stands for the domain of test cases, and PD-PS stands for the domain of parameters and parameter sets. The feature/component dependencies 6 are defined by the means that components 4 are associated with product features 1. The corresponding associations are represented in FIG. 2 by connecting lines, with the RS1 and RS2 components 4 being connected to the M1, M2, and M3 product features 1, for example. The feature/component dependencies 6 between the PS1, PS2, PS3 components 4 and the M1-M6 product features 3 are merely suggested in FIG. 2 for the sake of clarity. Storing the complete project information regarding the product features 1 and the components 4 as shown allows effortless finding of data, and relatively simple detection of inconsistencies when project data are changed.

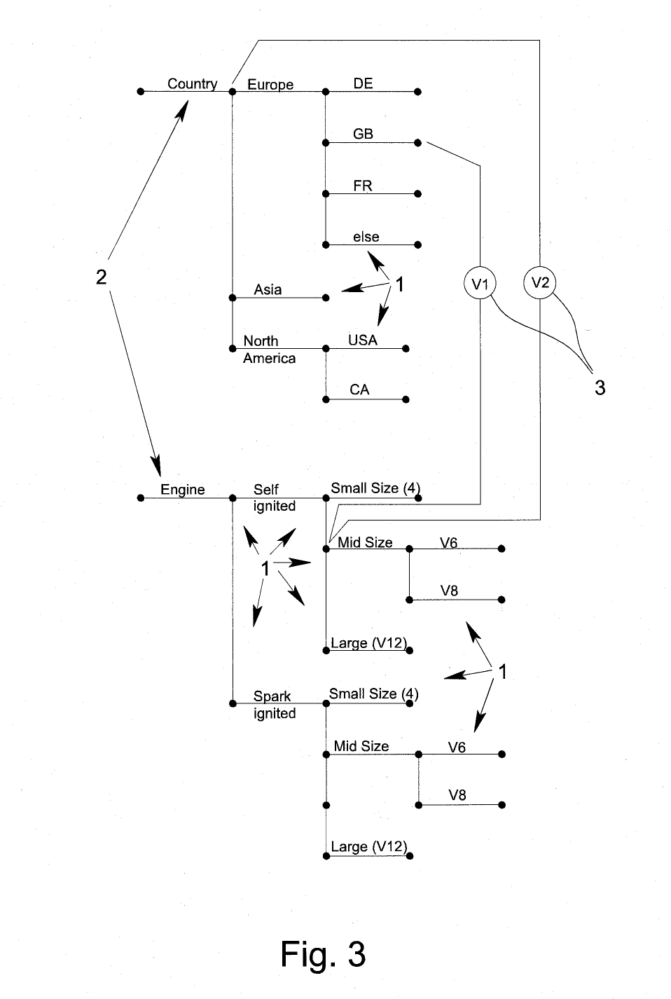

FIG. 3 illustrates how product variants 3 are defined by a selection of product features 1. For example, the V2 product variant 3 is characterized by the Europe product features 1 in the Country feature category 2, and the Self-ignited/Mid size product features 1 in the Engine feature category 2. The V1 product variant 3 relates to the sum of the country features GB and engine features 1 in the Engine feature category 2, namely Self-ignited/Mid size. At any rate, it is possible to determine from FIG. 3 that the V1, V2 product variants 3 are each defined by a selection of product features 1.

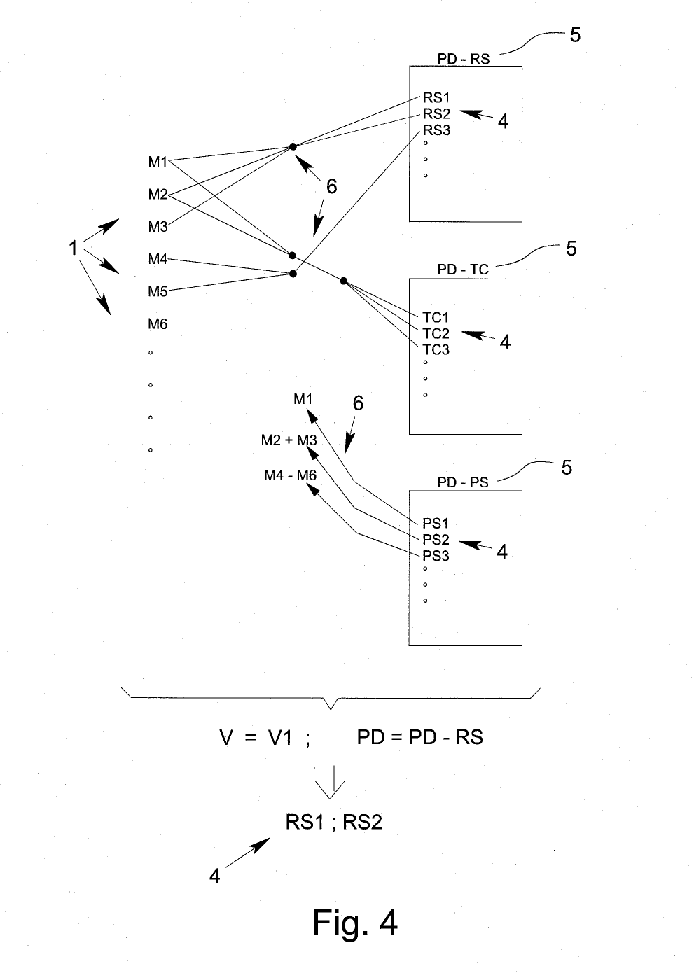

FIG. 4 illustrates that the product variant V1 is specified as a product variant of interest V, and that the domain PD-RS of requirements specifications is specified as the domain of interest PD. The components 4 that are located within the domain of interest PD while at the same time being connected to product features that are also part of the product variant of interest V can now be easily located by automated evaluation of the previously defined feature/component dependencies 6. Finally, automated output of the identified components 4 takes place, in this case the components RS1 and RS2, because in accordance with the assumption made above, the product feature M1 stands for the product feature GB, while only the RS1 and RS2 components 4 in the PD-RS domain 5 are connected with feature M1 through feature/component dependencies 6.

In the exemplary embodiment shown, the variant model 1, the domains 5, and the feature/component dependencies 6 are collected in a common database, which is to say that the data are managed in an integrated software solution and there is no need to gather the data from other applications through different software interfaces. Of course, the information collected in a common database may optionally be used and processed by different applications that are not part of the integrated software solution; in the present case, the data to be processed and the data that also have been processed by different project groups are organized centrally, with the overall result thus being a client-server structure.

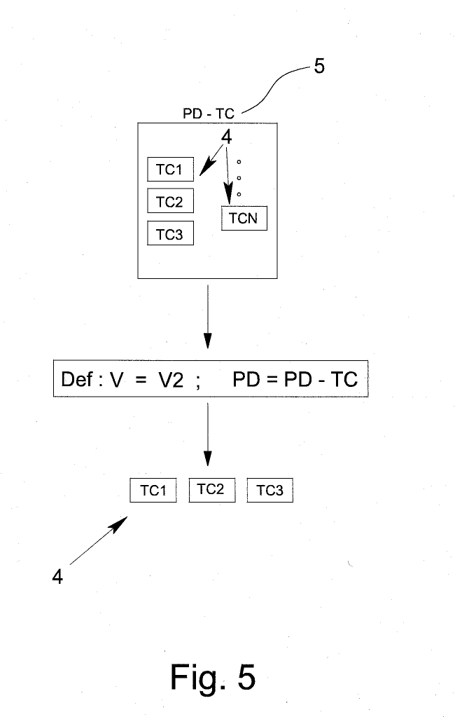

FIG. 5 shows that the TC1, . . . , TCN components 4 within the PD-TC domain 5 of test cases are stored in separate data units, indicated by the border around the individual test cases. It is now assumed that the product feature M2 stands in short form for the Europe product feature in the feature category 2 of Country. Taking into account the feature/component dependencies 6 indicated in FIG. 2, specifying the product variant of interest V=V2 and specifying the domain of interest PD=PD-TC results in the extraction of the relevant components 4, namely TC1, TC2, and TC3. The extracted components 4 were located solely through automated evaluation of the feature/component dependencies 6, wherein the automated evaluation here includes solely of an existence test of the dependencies. The fact that the components 4 within the PD-TC domain 5 are stored in separate data units facilitates output of the identified components 4, namely TC1, TC2, TC3, in the form of unchanged data units.

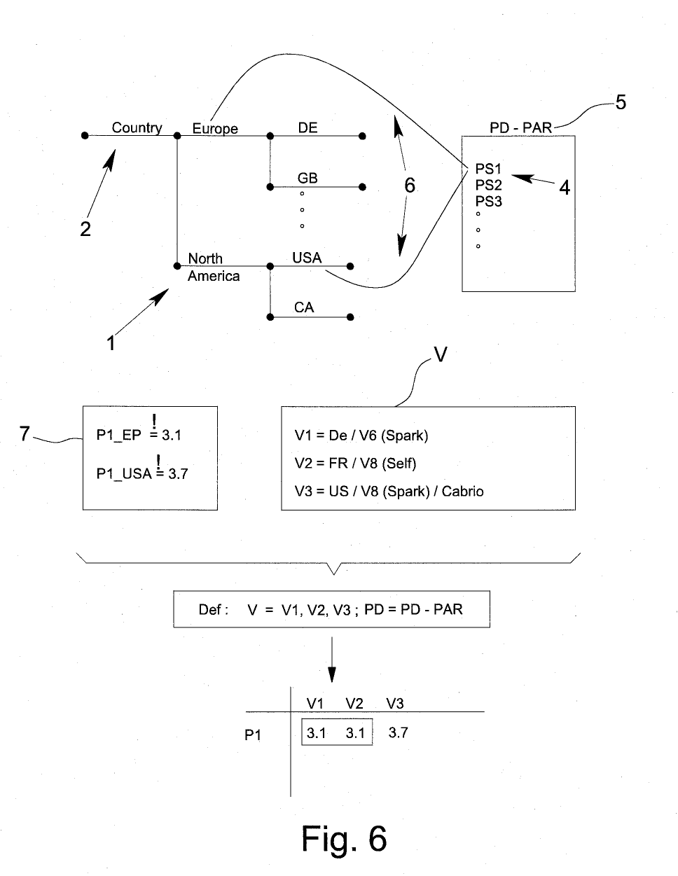

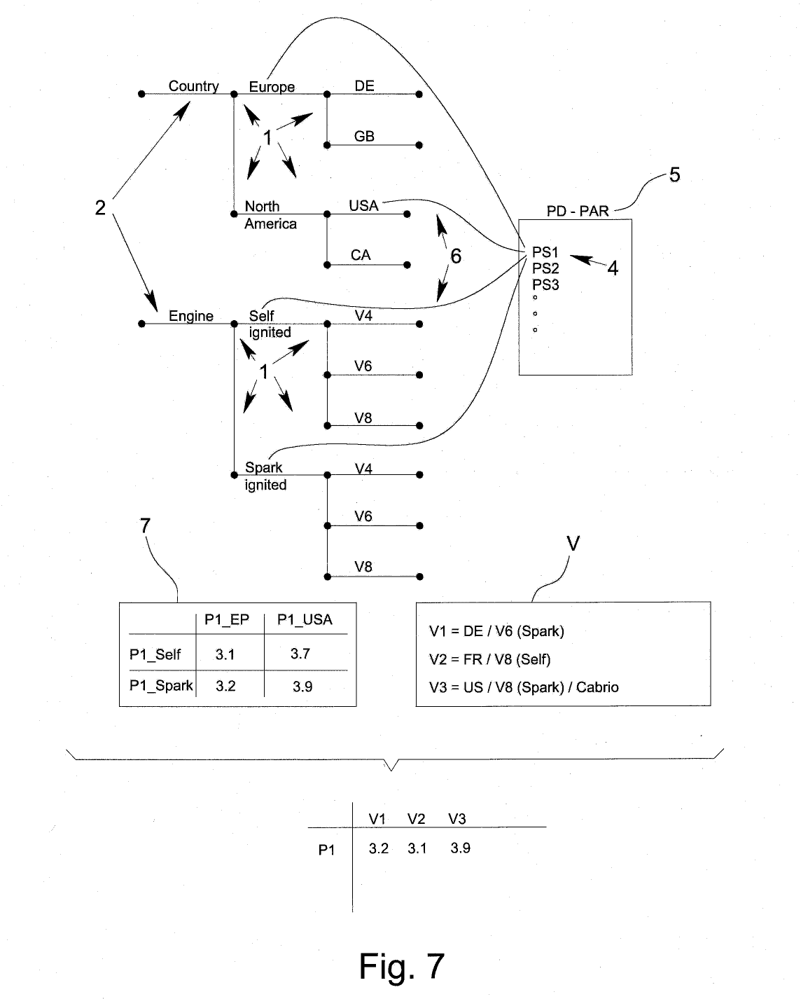

FIGS. 6 and 7 show noteworthy features of the method associated with the handling of feature/component dependencies 6 that are classified as value dependencies. First of all, it can be seen in FIG. 6 that the PD-PAR domain 5 of parameters has the PS1, PS2, and PS3 components 4. Two feature/component dependencies 6 are defined that are associated with the parameter P1, namely the first being Europe for product feature 1 and the second being USA for product feature 1. Since the two feature/component dependencies 6 are classified as value dependencies, the first thing needed are value specifications 7 for the component P1, and there must be the same number of these as is specified by the number of feature/component dependencies 6 within the single feature category 2, Country. This value specification, which is required by the method, is represented in the center of FIG. 6. The parameter P1 receives the value 3.1 for the dependency on the Europe feature 1, and receives the value 3.7 for the dependency on the USA product feature 1. The product variants V1, V2, V3 are defined as the product variants of interest V. The product variant of interest V1 includes the product feature combination DE/V6 (spark), the product variant of interest V2 corresponds to the product feature combination FR/V8 (self), and the product variant of interest V3 corresponds to the product feature combination US/V8 (spark)/cabrio [convertible].

Shown at the very bottom in FIG. 6 is the result produced by the application of the different product variants of interest V1, V2, V3. If it is assumed that V1, V2, or V3 is used alternatively as the product variant of interest V, and that the PD-PAR domain 5 of parameters is chosen as the domain of interest PD, then the value 3.1 is obtained for the parameter P1 for each of the product variants of interest V1, V2, and the value 3.7 is obtained for the parameter P1 for the product variant of interest V3. In testing the feature/component dependencies 6, the same procedure is followed here as was already explained above using the other exemplary embodiments. In addition, a procedure is used here according to which a feature/component dependency 6 defined at a higher level of the hierarchy for a product feature 1—in the present case, the dependency of the parameter P1 on the Europe product feature 1—is also transferred to the product variants that have the product feature at a lower level of the hierarchy. In the present example, this means that the specification P1_EP for the parameter P1 for the Europe product feature is also used for the country product features DE and FR since they are located at a lower level of the hierarchy below the Europe product feature 1. The values for the parameter P1 for the products of interest V1, V2 are shown surrounded by a border to indicate that these values are based on a single data storage, namely in the present case the data storage for the Europe product feature 1 for the parameter P1 (value specification 7).

FIG. 7 shows a more complex example that is based on feature/component dependencies 6 that are likewise classified as value dependencies. In contrast to the example in FIG. 6, features 1 are now specified in two feature categories 2, namely Country and Engine. The PS1 component 4 in the PD-PAR domain 5 of parameters now has four feature/component dependencies 6 that refer to the feature 1 in two different feature categories 2. The association of the feature/component dependencies 6 with different feature categories 2 has the result that the parameter PS1 must be supplied with data for all possible feature combinations, which takes place in the value specification 7. The value specification 7 is configured such that it permits the combinatorial possibilities for combining the product features 1 to be specified. Since feature/component dependencies 6 occur for pairs of product features 1 in two different feature categories 2, it is necessary to be able to carry out 2*2=4 value specifications. The product variants of interest V are identical to those in FIG. 6, just as is the filtering process on the different product variants of interest V1, V2, V3, which produces the results shown at the bottom of FIG. 7 for the applicable filtering activities. If the PS1 component 4 were to have two dependencies for one feature category and 20 dependencies for a second feature category, a value specification for 2*20=40 values would have to take place for the parameter.

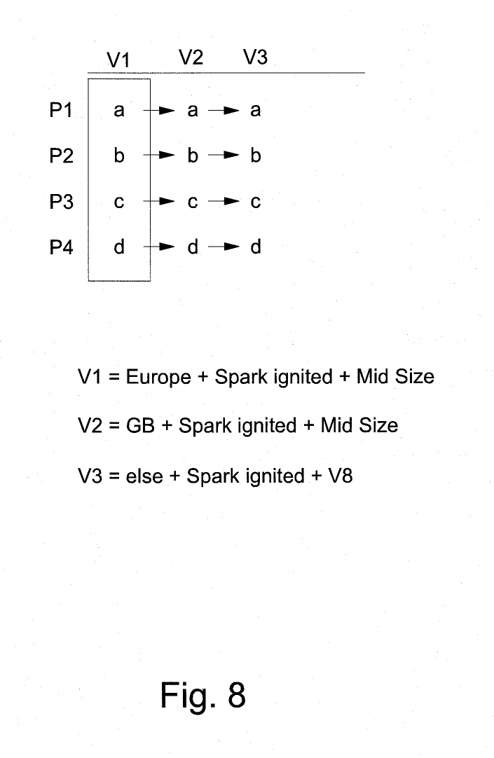

FIG. 8 shows a variant of the method for data management of product variants in which the existence of value dependencies in hierarchically structured feature categories is utilized. The starting point here is the variant model shown in FIG. 1, in which both the Country designation and the Engine designation are hierarchically structured, as already explained above. In the exemplary embodiment, concrete values have been assigned for the components 4, in the present case for the parameters P1, . . . , P4, with regard to the product variant V1, namely in the form of the values a, b, c, and d. If the particular parameters that apply to the variants V2 and V3 are now to be extracted from the data base, then these parameters can be identified automatically because of the hierarchical dependence within the feature categories of Country and Engine.

No parameter values have been specified for the product variant V2 of the control units to be used for Great Britain for spark-ignited, mid size engines. In this case, the feature/component dependency defined for a product feature on a higher level of the hierarchy is also transferred to the variants that have the product feature on a lower hierarchy level. In the present case, therefore, the specifications located on a higher level of the hierarchy for the product variant V1 for Europe are transferred to the same type of motor for Great Britain as well, which is to say to the product variant V2. However, if some parameters have been populated with values for the product variant V2, at least in part, then the locally specified values take precedence over the values that could be transferred through a hierarchical value dependence. The same principle is also used for the product variant V3, which applies to control units of all other European countries as regards spark-ignited engines with eight cylinders. Here, too, the parameters a, b, c, d specified for the product variant V1 can be transferred to the product variant V3 because of the hierarchical relationships. What is important is that the choice of motor type in the product variants V1 and V2 is immaterial insofar as the dependency of the parameter relates solely to the Country feature category.

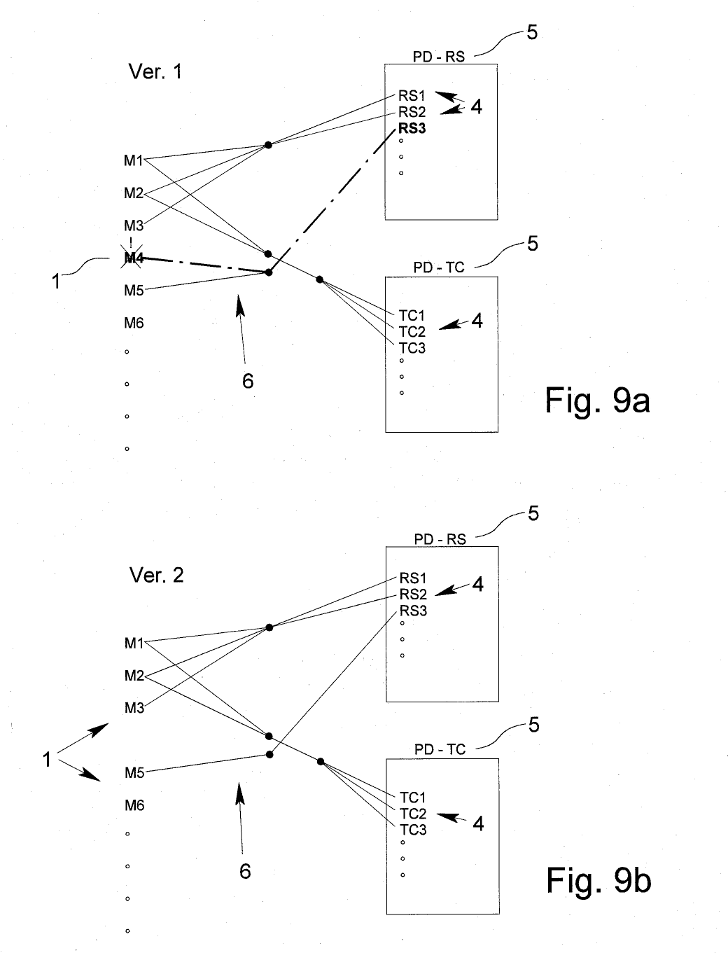

Shown in FIG. 9a, 9b is how certain impending inconsistencies can be recognized and avoided when the variant model and/or domain model is changed. In FIG. 9a, the deletion of the previously defined product feature 3 of M4 is stipulated, indicated by showing the product feature M4 crossed out. Now a determination is made, using evaluation of the existing feature/component dependencies 6, as to whether the product feature 1 to be deleted, namely M4, is associated with components 4. If an existing link is found, the existing feature/component dependency 6 is displayed, which is indicated in FIG. 9a by the dashed-and-dotted line. Deletion of the product feature M4 to be deleted is suspended. An expanded configuration of the method shown in FIG. 9a can be seen in FIG. 9b, in which possible conflicts are not only pointed out, but instead can also be remedied in such a way that inconsistencies in data management are avoided. After identification of the presence of an existing feature/component dependency 6, according to FIG. 9a a new version Ver. 2 of the database being managed is generated in the form of a copy of the database. The previously applicable database is likewise versioned, indicated in FIG. 9a by Ver. 1. In the newly generated version, Ver. 2, of the database being managed, the product feature M4 to be deleted is removed so that no feature/component dependencies that point nowhere arise or remain.

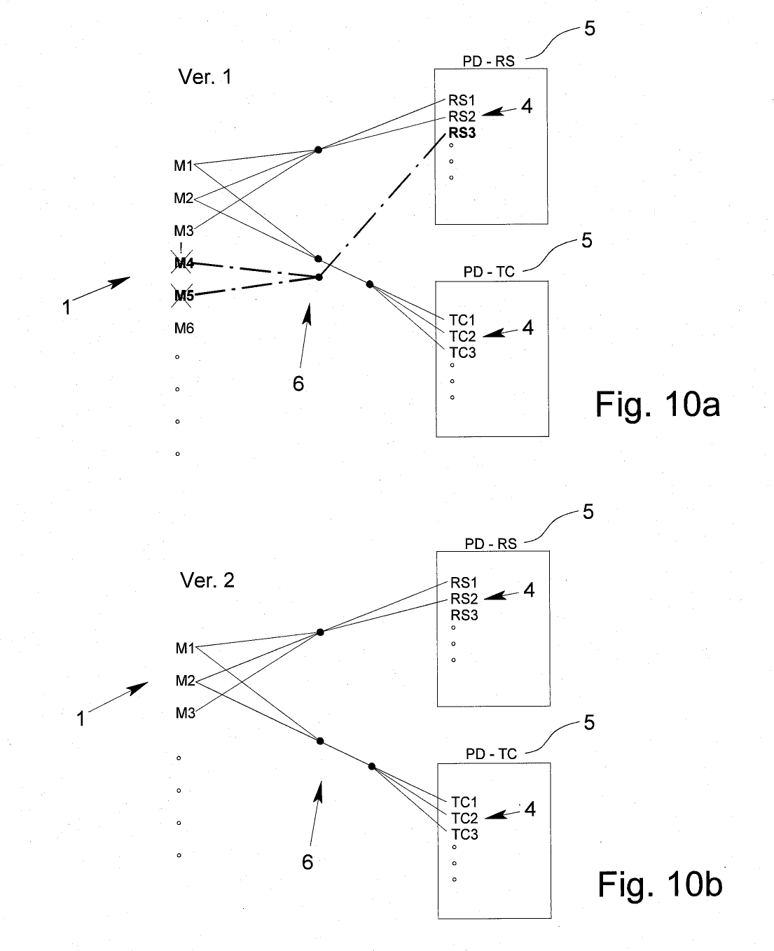

An even further developed variant of the method is shown in FIG. 10a, 10b. In contrast to the example in FIG. 9a, 9b, it is being stipulated in FIG. 10a, 10b that the product feature 1 in the form of product features M4 and M5 should be deleted. Just as in FIG. 9, a check is first made as to whether the product features M4 and M5 to be deleted are associated with components 4 so that a possible conflict is imminent. Upon identification of this dependency, a copy of the database being managed (Ver. 2) is made—also as in FIG. 9—with not only the product features M4 and M5 to be deleted being removed in the newly generated version Ver. 2 of the database being managed, but also the feature/component dependencies 6 associated with the deleted product features M4, M5. This was not easily possible in the exemplary embodiment shown in FIG. 9, since the component RS3 was still associated with another product feature 1 there, namely the product feature M5.

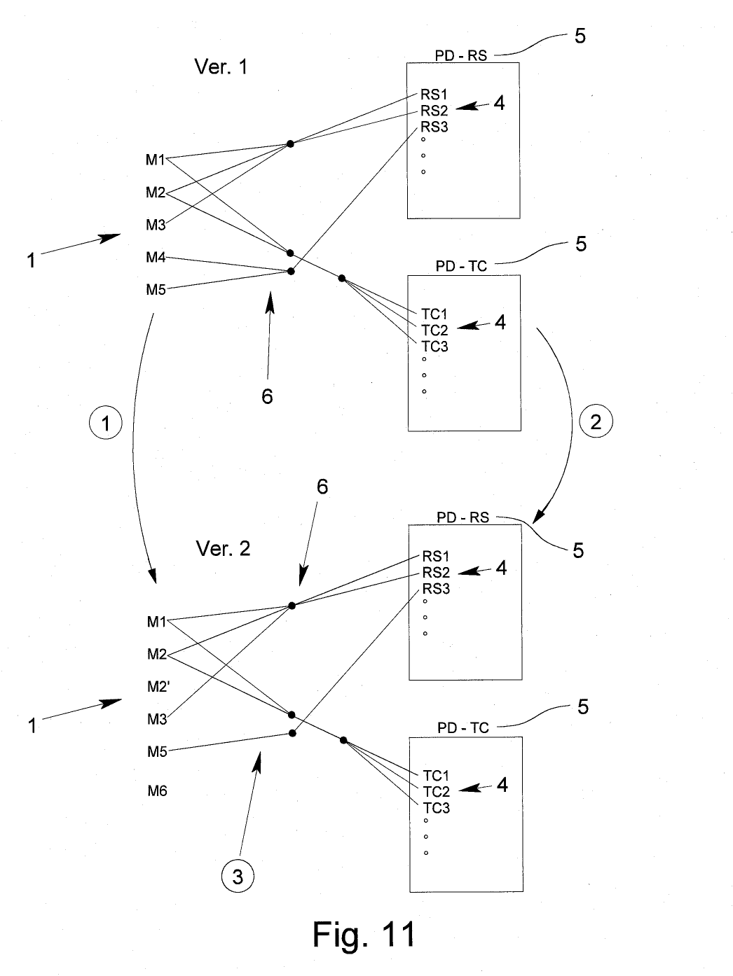

A further development of the claimed method is illustrated in FIG. 11, in which a new version Ver. 2 of the variant model is generated through a modifiable copy of an old version Ver. 1 of the variant model. Alternatively, a new version Ver. 2 of the existing domain model composed of all domains 5 and all feature/component dependencies 6 can be generated through a modifiable copy of an old version Ver. 1 of the domain model. What is important in any case is that such copies can be generated independently of one another with a next version number of the variant model and of the domain model being assigned. At any rate, in the example shown in FIG. 11, first a new version Ver. 2 of the variant model is produced, which is indicated by the circled number 1.

Version Ver. 2 of the variant model is subsequently changed; for example, the product feature M4 is deleted, and in addition the new product features M2′ and M6 are added. Once the variant model in version Ver. 2 has been changed relative to version Ver. 1, the desire arises to transfer the domain model to version Ver. 2 of the variant model, as well. To this end, provision is made that, during a change from an old version Ver. 1 of the variant model to a new version Ver. 2 of the variant model, first a new version Ver. 2 of the domain model is created by copying the old version Ver. 1 of the domain model, and the feature/component dependencies 6 associated with the old version Ver. 1 of the variant model are automatically transferred to the new version Ver. 2 of the variant model through the evaluation of references or through the evaluation of correspondences. The copying of the domain model from the old version Ver. 1 to the new version Ver. 2 is indicated in FIG. 11 by the step labeled with the circled number 2. For the sake of completeness, we note that directly after copying the domain model into version Ver. 2, the feature/component dependencies 6 originating from the components 4 are still associated with the product features of the variant model in version Ver. 1, which is not shown in detail in FIG. 11. These feature/component dependencies 6 between different versions of the database are automatically “deflected” to the product variants in version Ver. 2 through the evaluation of references or correspondences, as described above; this corresponds to the step labeled with the circled number 3.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A computer-implemented method for data management of product variants in control unit development, the method comprising:
specifying product features in a variant model;
specifying components in at least one domain;
defining feature/component dependencies by associating components with at least one product feature;
specifying at least one product variant of interest by selecting product features;
specifying at least one domain of interest;
automating identification of the components pertaining to the product variant of interest through automated evaluation of the feature/component dependencies; and
automating output of the identified components.

2. The computer-implemented method according to claim 1, wherein the variant model, the domains, and the feature/component dependencies are collected in a common database.

3. The computer-implemented method according to claim 1, wherein the defined feature/component dependencies are existence dependencies and/or value dependencies.

4. The computer-implemented method according to claim 1, wherein the components within a domain are stored in separate data units.

5. The computer-implemented method according to claim 4, wherein the automated evaluation of the feature/component dependencies includes an existence test for the dependency, in particular wherein the data units associated with the identified components are stored unchanged.

6. The computer-implemented method according to claim 1, wherein the components within a domain are stored in a common data unit.

7. The computer-implemented method according to claim 6, wherein the automated evaluation of the feature/component dependencies includes an existence test for the dependency, wherein the entries associated with the identified components are extracted from the common data unit and are output.

8. The computer-implemented method according to claim 7, wherein the entries associated with the identified components are extracted from the common data unit, and each entry is output separately or is output in a separate file.

9. The computer-implemented method according to claim 1, wherein the product features in at least one feature category are defined in a hierarchically structured manner.

10. The computer-implemented method according to claim 9, wherein a feature/component dependency defined for a product feature on a higher level of the hierarchy is also transferred to product variants that have the product feature on a lower level of the hierarchy.

11. The computer-implemented method according to claim 9, wherein one value dependency is defined in each case between one component and multiple product features in multiple feature categories and vk1*vk2* . . . *vkn value specifications are made for the component for the various combinations of the product features, and wherein vk1, vk2, . . . , vkn are the quantities of the feature/component dependencies in the form of value dependencies in the various feature categories VK1, VK2, . . . , VKn.

12. The computer-implemented method according to claim 1, wherein test cases in the domain of product tests are specified as components, or wherein models in the domain of product models are specified as components, or wherein parameters and/or parameter sets in the domain of product parameters are specified as components, or wherein requirements in the domain of requirements specifications are specified as components, or wherein test system descriptions in the domain of test systems are specified as components.

13. The computer-implemented method according to claim 1, wherein, when the deletion of a previously defined product feature is stipulated, a determination is made through evaluation of the existing feature/component dependencies as to whether the product feature to be deleted is associated with components and existing feature/component dependencies are pointed out, and wherein the deletion of the product feature to be deleted is suspended.

14. The computer-implemented method according to claim 13, wherein, when an existing feature/component dependency is present, a new version of the database being managed is generated in the form of a copy of the database being managed, if applicable following approval by the user, wherein the product feature to be deleted is removed in the newly generated version of the database being managed.

15. The computer-implemented method according to claim 14, wherein components that have feature/component dependencies solely with the deleted product feature are automatically deleted from the database being managed.

16. The computer-implemented method according to claim 1, wherein a new version of the variant model is generated through a modifiable copy of an old version of the variant model or wherein a new version of the domain model having all domains and all feature/component dependencies is generated through a modifiable copy of an old version of the domain model.

17. The computer-implemented method according to claim 16, wherein during a change from an old version of a domain model to a new version of the variant model, first a new version of the domain model is created by copying the old version of the domain model, and the feature/component dependencies associated with the old version of the variant model are automatically transferred to the new version of the variant model through the use of copied references and/or correspondences and/or markers in the new version of the variant model.

18. The computer-implemented method according to claim 17, wherein the automatic identification of correspondences takes place through comparison of names and/or feature combinations of the feature categories in the old version of the variant model with names and/or with feature combinations of the feature categories in the new version of the variant model.

19. The computer-implemented method according to claim 1, wherein the step of automating output of the identified components includes displaying the identified components on a display screen to a user.
